(19) United States
(12) Patent Application Publication
(10) Pub. No.: US 2017/0257708 A1
(43) Pub. Date: Sep. 7, 2017

(54) ACOUSTIC TRANSDUCER

(71) Applicant: Merry Electronics(Shenzhen) Co., Ltd., Guangdong (CN)

(72) Inventors: Jen-Yi Chen, Taichung (TW); Chao-Sen Chang, Taichung (TW); Chun-Chieh Wang, Taichung (TW); Yong-Shiang Chang, Taichung (TW)

(73) Assignee: Merry Electronics(Shenzhen) Co., Ltd., Guangdong (CN)

(21) Appl. No.: 15/604,670

(22) Filed: May 25, 2017

Related U.S. Application Data
(63) Continuation of application No. 14/056,221, filed on Oct. 17, 2013.

(51) Int. Cl. G01J 3/50

(52) U.S. Cl. CPC H04R 19/005; H04R 19/04; H04R 7/06

(57) ABSTRACT

An acoustic transducer includes a base plate, a vibrating membrane and a back plate. The vibrating membrane covers an opening of the base plate and has a plurality of conjoint vibratile portions. The acoustic transducer further has a connecting portion that is connected to a boundary between each two of the adjacent vibratile portions so as to allow the vibratile portions to generate vibration independently. The vibratile portions are geometrically different. Thereby, the vibratile portions can vibrate independently. This allows a designer to easily enhance the dynamic range of the acoustic transducer by geometrically modifying the vibrating membrane without increasing the total area of the vibrating membrane while maintaining a certain good degree of sensitivity and signal-to-noise ratio.

### CROSS-REFERENCE TO RELATED APPLICATION

This is a continuation application of and claims the priority benefit of U.S. application Ser. No. 14/056,221, filed on Oct. 17, 2013. The entirety of the above-mentioned patent application is hereby incorporated by reference herein and made a part of this specification.

### BACKGROUND OF THE INVENTION

1. Technical Field

The present invention relates to acoustic transducers used in MEMS microphones, and more particularly to an acoustic transducer having a single vibrating membrane that includes a plurality of vibratile portions, wherein the vibratile portions are configured to operate independently.

2. Description of Related Art

MEMS microphones are known to have advantages of being compact and easy to manufacture, so are extensively used in mobile phones. A conventional acoustic transducer 80, as shown in FIG. 7, has a base plate 81, a back plate 82 and a vibrating membrane 83. The vibrating membrane 83 covers an opening 811 of the base plate 81, and the back plate 82 is deposited on the base plate 81 and separated from the vibrating membrane 83 by an air gap 84. An electrode unit 85 is arranged on the back plate 82 and there is a fixing portion 821 that fixes an outer periphery of the vibrating membrane 83. The fixing portion 821 may be a hollow column or formed by a plurality of bulges arranged into a circle. Thereby, when the acoustic transducer 80 receives an acoustic wave, the vibrating membrane 83 vibrates and changes its distance from the electrode unit 85, causing change of capacitance.

However, with the development of smartphones that support video shooting and similar functions, the demand for compact microphones with high acoustical quality have been grown increasingly. Particularly, acoustic transducers are expected to maintain a certain good degree of sensitivity and signal-to-noise ratio when receiving sounds of various sound pressure levels (SPLs). The dynamic range of a vibrating membrane in an acoustic transducer depends on various factors, such as the material and the dimensions of the vibrating membrane of the vibrating membrane. For making an acoustic transducer responsive to different SPLs, it would be a relatively easy approach to geometrically modifying the vibrating membrane (e.g. width, thickness or area) during the manufacturing process while maintaining a certain good degree of sensitivity and signal-to-noise ratio. When the objective is to enhance the dynamic range of an acoustic transducer for its receipt of sounds, it generally needs plural vibrating membranes. However, for saving the material and minimizing the size of microphone, such vibrating membranes of different dimensions can though be traditionally assembled together, but they are subject to interference with each other. Thus, it has been a challenge for designers of acoustic transducers to simply enhance the dynamic range of the acoustic transducer without increasing the total area of the vibrating membrane while maintaining a certain good degree of sensitivity and signal-to-noise ratio.

### BRIEF SUMMARY OF THE INVENTION

In an embodiment, an acoustic transducer including a base plate, a single vibrating membrane, an elastic portion, and a connecting portion is provided. The single vibrating membrane is disposed above the base plate and includes an inner vibratile portion, an outer vibratile portion and an outer periphery, wherein the inner vibratile portion and the outer vibratile portion are conjoint, the outer vibratile portion encircles the inner vibratile portion, and the outer periphery encircles the outer vibratile portion. The elastic portion is arranged along peripheries of the inner vibratile portion and the outer vibratile portion. The connecting portion extends from the back plate and is provided between the back plate and the single vibrating membrane, wherein a boundary between the inner vibratile portion and the outer vibratile portion is fixed by the connecting portion, the inner vibratile portion and outer vibratile portion are different in rigidity, and the inner vibratile portion and the outer vibratile portion vibrate independently to respond various sound pressure levels.

In another embodiment, an acoustic transducer including a base plate, a single vibrating membrane, a back plate, an elastic portion, and a connecting portion is provided. The base plate has an opening. The single vibrating membrane includes a plurality of vibratile portions that are conjoint and an outer periphery that encircles the vibratile portions. The back plate includes a fixing portion to fix the outer periphery of the single vibrating membrane. The elastic portion is arranged along peripheries of the vibratile portions. The connecting portion extends from the back plate and is provided between the back plate and the single vibrating membrane to connect the back plate with the single vibrating membrane at a boundary between any two of the vibratile portions adjacent each other, wherein the vibratile portions are geometrically different from each other, the vibratile portions are different in rigidity, and the vibratile portions vibrate independently to respond various sound pressure levels.

In still another embodiment, an acoustic transducer including a base plate, a single vibrating membrane, a back plate, an elastic portion, an electrode unit, and a connecting portion is provided. The base plate has an opening. The single vibrating membrane is disposed on the base plate to cover the opening and includes a plurality of vibratile portions that are conjoint and an outer periphery that encircles the vibratile portions. The back plate fixes the outer periphery of the single vibrating membrane onto the base plate. The elastic portion is arranged along peripheries of the vibratile portions. The electrode unit is disposed on the back plate and is distributed above all the vibratile portions. The connecting portion extends from the back plate and is provided between the back plate and the single vibrating membrane to connect the back plate with the single vibrating membrane at a boundary between any two of the vibratile portions adjacent each other, wherein the vibratile portions are geometrically different from each other, the vibratile portions are different in rigidity, and the vibratile portions vibrate independently to generate variations of capacitance between the vibratile portions and the electrode unit.

### BRIEF DESCRIPTION OF THE SEVERAL VIEWS OF THE DRAWINGS

FIG. 1 is a transverse cross-sectional view of an acoustic transducer according to a first embodiment of the present invention.

FIG. 2 is a vertical cross-sectional view of the acoustic transducer according to the first embodiment of the present invention taken along Line 2-2 in FIG. 1.

FIG. 3 is another cross-sectional view of the acoustic transducer according to the first embodiment of the present invention, showing the connecting portion is a hollow column.

FIG. 4 is a partial perspective view of the acoustic transducer according to the first embodiment of the present invention.

FIG. 5 is a cross-sectional view of an acoustic transducer according to a second embodiment of the present invention.

FIG. 6 is another cross-sectional view of the acoustic transducer of FIG. 5 taken along Line 6-6.

FIG. 7 is a cross-sectional view of a conventional acoustic transducer.

### DETAILED DESCRIPTION OF THE INVENTION

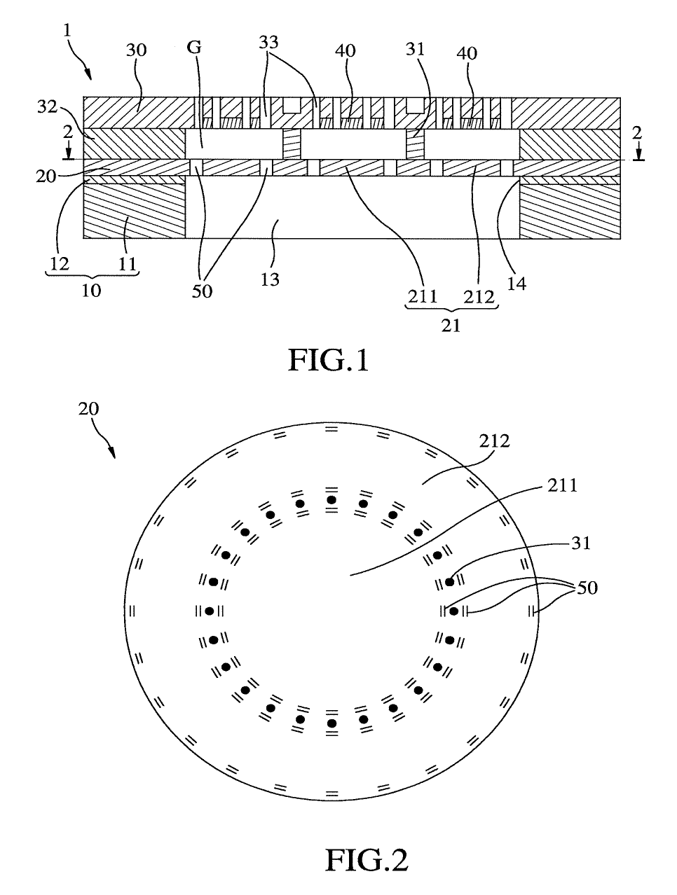

For further illustrating the features of the present invention, the following description, in conjunction with the accompanying drawings and preferred embodiments, is set forth as below. Referring to FIG. 1 through FIG. 3, according to a first embodiment of the present invention, an acoustic transducer 1 mainly comprises a base plate 10, a vibrating membrane 20 and a back plate 30. The structure and configuration of the components are described in the following sections.

As shown in FIG. 1, the base plate 10 is formed by a silicon bottom layer 11 and an insulation layer 12 deposited on the silicon bottom layer 11. The base plate 10 has a hollowed portion 13 extending between two sides of the base plate 10 and forming a round opening 14 at the insulation layer 12 for acoustic waves to pass therethrough.

The vibrating membrane 20 is deposited on the base plate 10 and covers the opening 14. The vibrating membrane 20 has a plurality of vibratile portions 21 that are conjoint. In the present embodiment, the vibrating membrane 20 is round and the vibratile portions 21 are provided in an amount of two, including a round inner vibratile portion 211 and a ring-like outer vibratile portion 212 that encircles the outer periphery of the inner vibratile portion 211. The inner vibratile portion 211 and outer vibratile portion 212 have a substantially even thickness and includes different geometric shapes.

It is to be noted that the inner vibratile portion 211 and the outer vibratile portion 212 are not limited to the combination of round and ring-like shapes, and may alternatively be a combination of a rectangular portion and a round-outside square-inside ring, or a different geometric combination. Also, the opening 14 is not necessarily to be round, and may be square or of another shape.

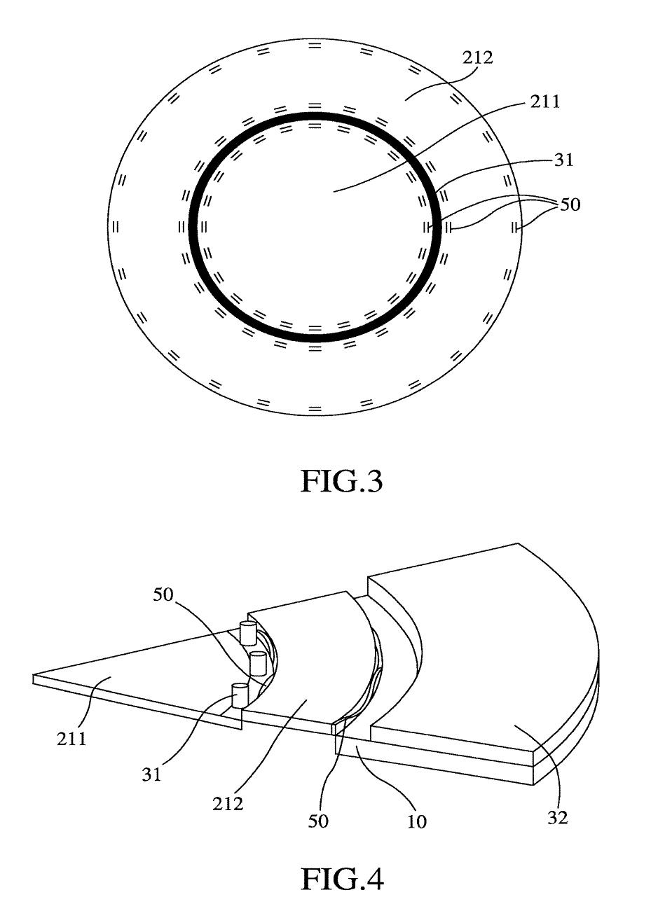

The back plate 30 is covered on the base plate 10 from above, so that an air gap G is formed between the back plate 30 and the base plate 10. The back plate 30 has a connecting portion 31, which extends from a bottom surface of the back plate 30 toward a top surface of the vibrating membrane 20, and is connected to the boundary between the inner vibratile portion 211 and the outer vibratile portion 212. In the present embodiment, the connecting portion 31 comprises a plurality of columns arranged along the boundary between the inner vibratile portion 211 and the outer vibratile portion 212 (as shown in FIG. 2). The connecting portion 31 may alternatively comprise a plurality of rectangular prisms, or a single hollow column (as shown in FIG. 3). The back plate 30 further has a plurality of sound holes 33 for allowing acoustic waves to pass therethrough. The number of the sound holes 33 may vary according to practical needs. Depending on the means of packaging, the acoustic transducer 1 may have acoustic waves transmitted from the sound hole 33 to the vibrating membrane 20. In addition, while the outer periphery of the vibrating membrane 20 is firmly fixed to the base plate 10, in the present embodiment we further uses a fixing portion 32 to encircle and fix the outer periphery of the vibrating membrane 20 so as to make the connecting portion 31 connected to the back plate 30 and the vibrating membrane 20 more directly and more firmly. People skilled in the art can save the use of the fixing portion 32 or allow the two laterals of the back plate 30 to be connected with the base plate 10 directly, and the back plate 30 does not contact the vibrating membrane 20, as appropriate in view of practical needs.

Additionally, the connecting portion 31 in the first embodiment may alternatively extend from the vibrating membrane 20 toward the back plate 30 and is connected to the boundary between the inner vibratile portion 211 and the outer vibratile portion 212, with the same technical function achieved.

In response to acoustic waves passing through the hollowed portion 13 and reaching the vibrating membrane 20, the inner vibratile portion 211 and the outer vibratile portion 212 vibrate vertically with respect to the base plate 10, so as to change their distances from the electrode unit 40 deposited on the back plate 30, thereby causing variations of capacitance. Since the connecting portion 31 connects the back plate 30 and the inner vibratile portion 211 with the boundary between the inner vibratile portion 211 and the outer vibratile portion 212, the vibration of the inner vibratile portion 211 is prevented from being transmitted to the outer vibratile portion 212, and vice versa. Thereby, the inner vibratile portion 211 and the outer vibratile portion 212 can vertically vibrate independently without interfering with each other (as shown in FIG. 4). Also, since the inner vibratile portion 211 and the outer vibratile portion 212 are substantially identical in terms of thickness, the rigidity of each of the vibratile portions 21 is determined by its geometry. The vibratile portions 21 of different levels of rigidity respond to acoustic waves with different dynamic ranges. Therefore, a designer of an acoustic transducer can modulate the desired dynamic range by simply modifying the vibratile portions 21 geometrically while maintaining a certain good degree of sensitivity and signal-to-noise ratio.

It is to be explained that the present invention involves dividing a single vibrating membrane 20 into the vibratile portions 21 that have different geometric shape, so the total area of the vibrating membrane 20 needs not to increase. Since the areas of the individual vibratile portions 21 are smaller than that of the original vibrating membrane, the vibratile portions 21 consequently have higher rigidity and lower sensitivity. For addressing this problem, the designer of the a acoustic transducer 1 may optionally set a plurality of elastic members 50 along the periphery of each of the vibratile portions 21, and make the elastic coefficient of the elastic member 50 deforming toward the back plate 30 smaller than the elastic coefficient of the vibratile portion 21 deforming toward the back plate 30. By this way, the designer may have more flexibility in modulating the resulting dynamic range.

Furthermore, the scope of each of the vibratile portions 21 is defined by the site where the connecting portion 31 contacts the vibrating membrane 20 and by the connected part of the outer periphery of the vibrating membrane 20, so that each of the vibratile portions 21 can vibrate independently. In the present embodiment, the vibratile portions 21 are conjoint with each other to form a complete vibrating membrane 20. However, in a case where the boundary between the vibratile portions 21 comprises a physical interval, and all the peripheries of the vibratile portions 21 are fixed by the connecting portion 31 or partially fixed to the base plate 10 and partially fixed by the connecting portion 31, the vibratile portions 21 can also vibrate independently, and is also within the scope of the present invention.

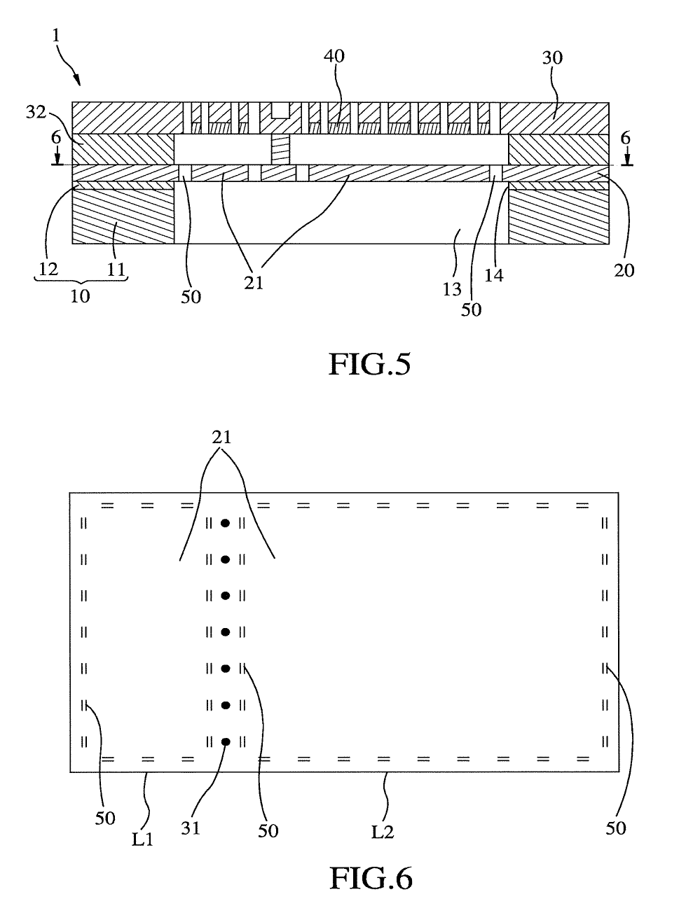

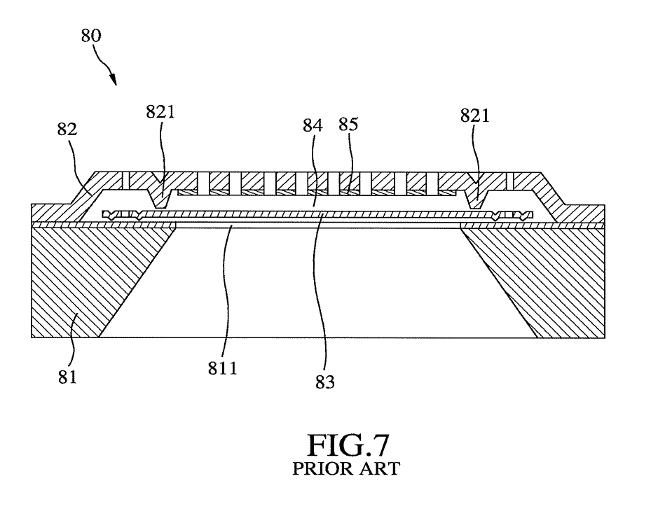

In a second embodiment of the present invention, as shown in FIG. 5 and FIG. 6, an acoustic transducer 1 is structurally similar to the first embodiment except that the opening 14 is a square hole and the vibrating membrane 20 is rectangular. In this embodiment, the connecting portion 31 comprises a plurality of columns linearly arranged along the boundary between two rectangular vibratile portions 21 in a direction parallel to the width side W of the vibrating membrane 20. The two vibratile portions 21 are substantially equal in terms of thickness but have different aspect ratios. Thereby, the designer of the acoustic transducer can modulate the desired dynamic range more easily by modifying side lengths (L1 & L2) of the two vibratile portions 21.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An acoustic transducer, comprising:
a base plate;
a single vibrating membrane disposed above the base plate and comprising an inner vibratile portion, an outer vibratile portion and an outer periphery, wherein the inner vibratile portion and the outer vibratile portion are conjoint, the outer vibratile portion encircles the inner vibratile portion, and the outer periphery encircles the outer vibratile portion;
an elastic portion arranged along peripheries of the inner vibratile portion and the outer vibratile portion; and
a connecting portion extending from the back plate and being between the back plate and the single vibrating membrane, wherein a boundary between the inner vibratile portion and the outer vibratile portion is fixed by the connecting portion, the inner vibratile portion and outer vibratile portion are different in rigidity, and the inner vibratile portion and the outer vibratile portion vibrate independently to respond various sound pressure levels.

2. The acoustic transducer of claim 1 further comprising a back plate disposed above the single vibrating membrane, wherein the base plate comprises a fixing portion that fixes the outer periphery of the single vibrating membrane onto the base plate.

3. The acoustic transducer of claim 2, wherein the base plate comprises a round hole covered by the single vibrating membrane.

4. The acoustic transducer of claim 1, wherein the inner vibratile portion is a round inner vibratile portion and the outer vibratile portion is a ring-like outer vibratile portion that encircles the round inner vibratile portion.

5. The acoustic transducer of claim 1, wherein the connecting portion comprises a plurality of separated solid columns arranged along the boundary between the inner vibratile portion and the outer vibratile portion.

6. The acoustic transducer of claim 1, wherein the connecting portion is a hollow column that covers the boundary between the inner vibratile portion and the outer vibratile portion.

7. The acoustic transducer of claim 1, wherein the inner vibratile portion and the outer vibratile portion are substantially identical in thickness.

8. The acoustic transducer of claim 1, wherein the inner vibratile portion and the outer vibratile portion are geometrically different from each other.

9. The acoustic transducer of claim 1, wherein an elastic coefficient of the elastic portion is smaller than an elastic coefficient of the inner vibratile portion and the outer vibratile portion.

10. The acoustic transducer of claim 1 further comprising an electrode unit disposed on the back plate, and the electrode unit being distributed above the inner vibratile portion and the outer vibratile portion.

11. An acoustic transducer, comprising:
a base plate having an opening;
a single vibrating membrane comprises a plurality of vibratile portions that are conjoint and an outer periphery that encircles the vibratile portions;
a back plate comprising a fixing portion to fix the outer periphery of the single vibrating membrane;
an elastic portion arranged along peripheries of the vibratile portions; and
a connecting portion extending from the back plate and being between the back plate and the single vibrating membrane to connect the back plate with the single vibrating membrane at a boundary between any two of the vibratile portions adjacent each other, wherein the vibratile portions are geometrically different from each other, the vibratile portions are different in rigidity, and the vibratile portions vibrate independently to respond various sound pressure levels.

12. The acoustic transducer of claim 11, wherein the single vibrating membrane is disposed on the base plate to cover the opening of the base plate, wherein a shape of the single vibrating membrane corresponds to a shape of the opening.

13. The acoustic transducer of claim 11, wherein the connecting portion comprises a plurality of separated solid columns arranged along the boundary between any two of the vibratile portions adjacent each other.

14. The acoustic transducer of claim 11, wherein the connecting portion is a hollow column that covers the boundary between any two of the vibratile portions adjacent each other.

15. The acoustic transducer of claim 11, wherein the vibratile portions are substantially identical in thickness.

16. The acoustic transducer of claim 11, wherein an elastic coefficient of the elastic portion is smaller than an elastic coefficient of the vibratile portions.

17. An acoustic transducer, comprising:
a base plate having an opening;
a single vibrating membrane disposed on the base plate to cover the opening and comprising a plurality of vibratile portions that are conjoint and an outer periphery that encircles the vibratile portions;
a back plate, fixing the outer periphery of the single vibrating membrane onto the base plate;
an elastic portion arranged along peripheries of the vibratile portions;
an electrode unit disposed on the back plate, and the electrode unit being distributed above all the vibratile portions;
a connecting portion extending from the back plate and being between the back plate and the single vibrating membrane to connect the back plate with the single vibrating membrane at a boundary between any two of the vibratile portions adjacent each other, wherein the vibratile portions are geometrically different from each other, the vibratile portions are different in rigidity, and the vibratile portions vibrate independently to generate variations of capacitance between the vibratile portions and the electrode unit.

18. The acoustic transducer of claim 17, wherein the connecting portion comprises a plurality of separated solid columns arranged along the boundary between any two of the vibratile portions adjacent each other.

19. The acoustic transducer of claim 17, wherein the connecting portion is a hollow column that covers the boundary between any two of the vibratile portions adjacent each other.

20. The acoustic transducer of claim 17, wherein the vibratile portions are substantially identical in thickness.
